(19) United States
(12) Patent Application Publication
(10) Pub. No.: US 2020/0088033 A1
(43) Pub. Date: Mar. 19, 2020

(54) SUPERCHARGER PROTECTION IN AN OPPOSED-PISTON ENGINE WITH EGR

(71) Applicant: ACHATES POWER, INC., San Diego, CA (US)

(72) Inventors: MANOHAR VITTAL, San Diego, CA (US); SURAMYA D. NAIK, Milpitas, CA (US)

(73) Assignee: ACHATES POWER, INC., San Diego, CA (US)

(21) Appl. No.: 16/663,756

(22) Filed: Oct. 25, 2019

Related U.S. Application Data
(63) Continuation of application No. PCT/US2018/033153, filed on May 17, 2018.
(60) Provisional application No. 62/517,709, filed on Jun. 9, 2017.

(51) Int. Cl. F01B 7/02; F02M 26/41

(52) U.S. Cl. CPC F01B 7/02; F02B 29/0475; F02M 26/41

(57) ABSTRACT

In a supercharged, two-stroke cycle, opposed-piston engine with an EGR loop, exhaust gas recirculated to a charge air channel through which charge air is provided to a supercharger inlet is cleansed of particulate materials by a particulate filter located in the EGR channel to capture and oxidize particulate matter before EGR is allowed to flow through the supercharger and any cooler in the EGR flow path. A diesel oxidation catalyst device may be provided in the EGR channel, in series with the particulate filter.

### PRIORITY

This application is a continuation of PCT application PCT/US2018/033153, filed May 17, 2018, which claims priority to US provisional application for patent 62/517,709, filed 9 Jun. 2017.

### FIELD OF THE INVENTION

The invention is directed to an opposed-piston internal combustion engine with an air handling system uniquely equipped to protect a supercharger from damaging effects attributable to a exhaust gas recirculation.

More particularly, the EGR loop is uniquely configured to mitigate the effects of particles that are present in exhaust gas being recirculated to a stream of charge air that is fed to the input of a supercharger.

### BACKGROUND OF THE INVENTION

Gas flow through a two-stroke cycle, opposed-piston engine is not assisted by any pumping action of the pistons, as occurs in a four-stroke engine with a single piston in each cylinder. Charge air must be continuously pumped by means external to the cylinders. Such means typically include a mechanically-driven supercharger situated downstream of a turbocharger in the direction of charge air flow. The supercharger maintains a positive pressure drop across the engine that ensures forward motion through the engine of the charge air and exhaust at all engine speeds and loads, a condition that cannot be met by the turbocharger. In addition, the supercharger provides needed boost quickly in response to torque demands to which the turbocharger responds more slowly. In many cases, cold start of a two-stroke cycle, opposed-piston engine is enabled by the supercharger pumping air through the charge air system. Finally, for those two-stroke cycle opposed-piston engine configurations equipped with high-pressure exhaust gas recirculation (EGR), the supercharger maintains a positive pressure drop across the EGR loop that ensures the transport of exhaust gas through it.

Manifestly, reliable operation of the supercharger is a critical factor in meeting the performance and emission goals of a two-stroke cycle opposed-piston engine. Poor, deteriorating, or otherwise impaired supercharger operation must therefore be avoided. However, the integrity of supercharger operation can be severely compromised by the recirculated exhaust gas.

Exhaust gas recirculation is an effective means for reducing certain exhaust impurities that are produced by burning fuel in a high temperature combustion process. Recirculation of a portion of exhaust gases into an incoming stream of charge air serves to reduce the amount of oxygen in the charge air provided to the engine, thereby reducing peak temperatures of combustion. However, recirculated exhaust gas, particularly, exhaust recirculated through a high-pressure EGR loop, typically includes particulate matter (PM) such as soot and unburned hydrocarbons, both of which are harmful to air handling components in the charge air system. A price paid for high-pressure EGR operation is a reduction in supercharger performance and lifetime. In particular, PM introduced by recirculation of exhaust into the charge air deposits readily on the surfaces of internal components of the supercharger such as rotors, housing, bearings, gears, etc., largely due to thermophoresis. Accumulation of PM deposits can lead to reduction in supercharger performance resulting in increased pumping loss and reduced operational efficiency. Ultimately, fouling and clogging can cause failure of the device.

Accordingly, it is desirable to solve the problem of supercharger vulnerability to damaging effects of high pressure EGR in a two-stroke cycle, opposed-piston engine by providing for oxidation of PM in the EGR loop.

### SUMMARY OF THE INVENTION

According to an aspect of the invention, in a supercharged, two-stroke cycle, opposed-piston engine with an EGR loop, exhaust gas recirculated to a charge air channel through which charge air is provided to a supercharger inlet is cleansed of particulate materials by a particulate filter located in the EGR channel to capture and oxidize particulate matter before EGR is allowed to flow through the supercharger and any cooler in the EGR flow path.

In some respects, a particulate filter is positioned in the high-pressure EGR loop EGR to trap PM and/or hydrocarbons upstream of the supercharger and any cooler in the EGR flow path to keep them from fouling. In some aspects, the particulate filter is a regenerative-type filter in which increases in pressure drop as soot particles are captured are offset by continuously regenerating the filter during engine operation.

In other aspects, a Diesel Oxidation Catalyst (DOC) device is provided in the EGR channel to oxidize hydrocarbons, CO, and other materials present in exhaust gas obtained for recirculation. Preferably, the DOC device is situated in series with the particulate filter. In some aspect he DOC device is situated upstream of the particulate filter in the EGR channel.

### BRIEF DESCRIPTION OF THE DRAWINGS

FIG. 1 is a diagram of an opposed-piston engine equipped with an air handling system and is properly labeled “Prior Art.”

FIG. 2 is a schematic diagram showing an air handling system of an opposed-piston engine equipped with a particulate filter according to a first embodiment of the invention.

FIG. 3 is a schematic diagram showing an air handling system of an opposed-piston engine equipped with a Diesel Oxidation Catalyst (DOC) placed in the EGR channel, in series with the particulate filter, according to a second embodiment of the invention.

### DETAILED DESCRIPTION OF THE PREFERRED EMBODIMENTS

A two-stroke cycle engine is an internal combustion engine that completes a cycle of operation with a single complete rotation of a crankshaft and two strokes of a piston connected to the crankshaft. The strokes are typically denoted as compression and power strokes. One example of a two-stroke cycle engine is an opposed-piston engine in which two pistons are disposed in the bore of a cylinder for reciprocating movement in opposing directions along the central axis of the cylinder. Each piston moves between a bottom center (BC) location where it is nearest one end of the cylinder and a top center (TC) location where it is furthest from the one end. The cylinder has ports formed in the cylinder sidewall near respective BC piston locations. Each of the opposed pistons controls one of the ports, opening the port as it moves to its BC location, and closing the port as it moves from BC toward its TC location. One of the ports serves to admit charge air (sometimes called “scavenging air”) into the bore, the other provides passage for the products of combustion out of the bore; these are respectively termed “intake” and “exhaust” ports (in some descriptions, intake ports are referred to as “air” ports or “scavenge” ports). In a uniflow-scavenged opposed-piston engine, pressurized charge air enters a cylinder through its intake port as exhaust gas flows out of its exhaust port, thus gas flows through the cylinder in a single direction (“uniflow”)—from intake port to exhaust port.

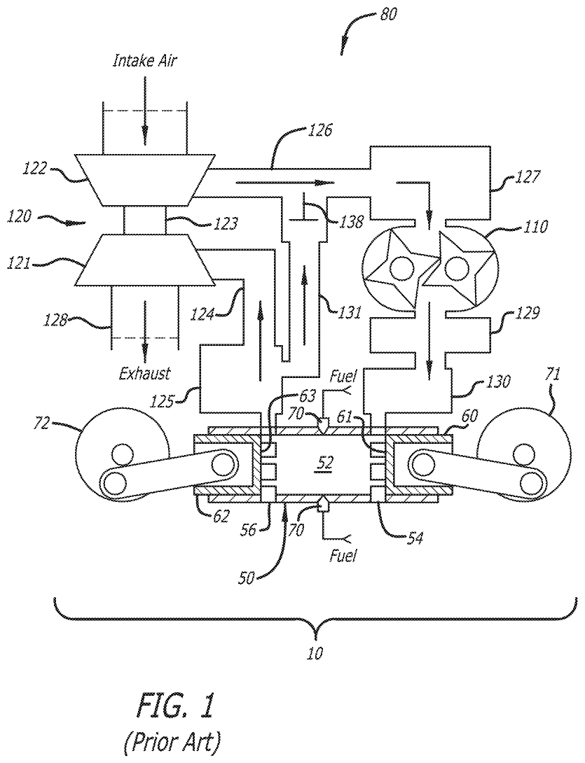

With reference to FIG. 1, a two-stroke cycle internal combustion engine is embodied in an opposed-piston engine 10 having at least one ported cylinder 50. For example, the engine may have one ported cylinder, two ported cylinders, three ported cylinders, or four or more ported cylinders. Each ported cylinder 50 has a bore 52 and longitudinally spaced intake and exhaust ports 54 and 56 formed or machined in respective ends of a cylinder wall. Each of the intake and exhaust ports 54 and 56 includes one or more circumferential arrays of openings in which adjacent openings are separated by a solid bridge. In some descriptions, each opening is referred to as a “port”; however, the construction of a circumferential array of such “ports” is no different than the port constructions shown in FIG. 1. Pistons 60 and 62 are slideably disposed in the bore 52 of each cylinder with their end surfaces 61 and 63 opposing one another. Movements of the pistons 60 control the operations of the intake ports 54. Movements of the pistons 62 control the operations of the exhaust ports 56. Thus, the ports 54 and 56 are referred to as “piston controlled ports”. Pistons 62 controlling the exhaust ports (“exhaust pistons”) are coupled to a crankshaft 72. Pistons 60 controlling the intake ports of the engine (“intake ports”) are coupled to a crankshaft 71.

As pistons 60 and 62 approach respective TC locations, a combustion chamber is defined in the bore 52 between the end surfaces 61 and 63. Fuel is injected directly into the combustion chamber through at least one fuel injector nozzle 70 positioned in an opening through the sidewall of a cylinder 50. The fuel mixes with charge air admitted through the intake port 54. As the mixture is compressed between the end surfaces it reaches a temperature that causes the fuel to ignite; in some instances, ignition may be assisted, as by spark or glow plugs. Combustion follows.

The engine 10 has an air handling system 80 that manages the transport of charge air provided to, and exhaust gas produced by, the engine 10 during operation of the engine. A representative air handling system construction includes a charge air subsystem and an exhaust subsystem. The charge air subsystem receives and compresses air and includes a charge air channel that delivers the compressed air to the intake port or ports of the engine. The charge air subsystem may comprise one or both of a turbine-driven compressor and a supercharger. The charge air channel typically includes at least one air cooler that is coupled to receive and cool the charge air (or a mixture of gases including charge air) before delivery to the intake ports of the engine. The exhaust subsystem includes an exhaust channel that transports exhaust products from exhaust ports of the engine for delivery to other exhaust components and release to the ambient atmosphere.

A typical air handling system for an opposed-piston engine is shown in FIG. 1. The air handling system 80 may comprise a turbocharger 120 with a turbine 121 and a compressor 122 that rotate on a common shaft 123. The turbine 121 is coupled to the exhaust subsystem and the compressor 122 is coupled to the charge air subsystem. The turbocharger 120 extracts energy from exhaust gas that exits the exhaust ports 56 and flows into an exhaust channel 124 that is fluidly coupled to an exhaust manifold, plenum, or chest 125 (collectively, “exhaust manifold”, for convenience) which collects exhaust gases output through the exhaust ports 56. In this regard, the turbine 121 is rotated by exhaust gas passing through it. This rotates the compressor 122, causing it to generate charge air by compressing fresh air. Charge air output by the compressor 122 flows through a charge air channel 126. The charge air channel 126 includes the compressor 122, a supercharger 110 downstream of the compressor in the direction of charge air flow, and an intake manifold, plenum, or chest 130 (collectively, “intake manifold”, for convenience). The charge air channel may further include at least one charge air cooler 127 (hereinafter, “cooler”) to receive and cool the charge air before delivery to the intake port or ports of the engine. Charge air transported to the supercharger 110 is output to the intake manifold 130. The intake ports 54 receive charge air pumped by the supercharger 110 via the intake manifold 130. A second cooler 129 may be provided between the output of the supercharger 110 and the input to the intake manifold 130.

The air handling system 80 is equipped to reduce NOx emissions produced by combustion by recirculating a portion of the exhaust gas produced by combustion through the ported cylinders of the engine. The recirculated exhaust gas is mixed with charge air to lower peak combustion temperatures, which reduces production of NOx. This process is referred to as exhaust gas recirculation (“EGR”). The EGR construction shown obtains a portion of the exhaust gases flowing from the exhaust manifold 125 during scavenging and transports it via an EGR channel 131 into the stream of charge air in the charge air subsystem. The recirculated exhaust gas flows through the EGR channel 131 under the control of a valve 138 (this valve may also be referred to as the “EGR valve”). The EGR arrangement of FIG. 1 is referred to as a high pressure EGR loop because the portion of the exhaust gas to be recirculated is taken from the exhaust channel 124, upstream of the inlet of the turbine 121 in the direction of exhaust flow, where the exhaust gas pressure is relatively higher than at the turbine's outlet.

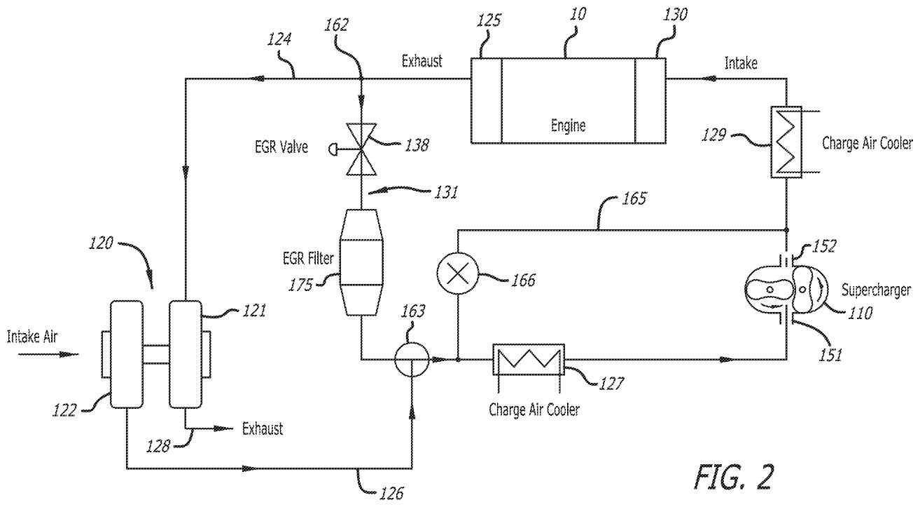

First Embodiment: FIG. 2 shows the air handling system 80 in greater detail, equipped according to a first embodiment of the invention in which a particulate filter is disposed in the EGR channel to reduce the concentration of PM in the exhaust being recirculated to the charge air channel.

Intake air is provided to the compressor 122. As the compressor 122 rotates, compressed air flows from the compressor's outlet, through the charge air channel 126, and into the inlet 151 of the supercharger 110. Charge air pumped by the supercharger 110 flows through the supercharger's outlet 152 into the intake manifold 130. Pressurized charge air is delivered via the intake manifold 130 to the intake ports of the engine. Exhaust gases from the exhaust ports of the engine flow from the exhaust manifold 125 into the inlet of the turbine 121 and from the turbine's outlet into the exhaust outlet channel 128. In some instances, one or more after treatment (AT) devices may be provided in the exhaust outlet channel 128. Exhaust gas recirculated via the high-pressure EGR channel 131 is obtained from the exhaust channel 124 by a tee coupling 162 from the exhaust channel 124. between the exhaust manifold 125 and the input to the turbine 121. The recirculated exhaust is delivered by the EGR channel 131 for mixing with fresh charge air at a point between the output of the compressor 122 and the supercharger inlet 151. The amount of exhaust flowing through the EGR channel 131 is controlled by the EGR valve 138. The EGR channel 131 is coupled to the charge air subsystem via an EGR mixer 163 wherein the recirculated exhaust is combined with pressurized air output by the compressor 122. The mixer 163 outputs the charge air, which is supplied to the elements positioned downstream of the mixer including the supercharger 110.

The air handling system 80 is equipped for control of gas flow at separate control points in the charge air and exhaust channels. In the charge air channel, charge air flow and boost pressure may be controlled by operation of a recirculation channel 165 coupling the outlet 152 of the supercharger to the supercharger's inlet 151. In some instances, the channel 165 may be referred to as a “bypass channel” or a “shunt channel.” The recirculation channel 165 shunts charge air flow from the outlet 152 to the inlet 151 of the supercharger according to the setting of a recirculation valve 166. The recirculation channel enables control of the flow of charge air into, and thus the pressure in, the intake manifold 130. Other valves (which are not shown) may be provided at other control points in the air handling system. In other cases (not shown) the supercharger 110 may be coupled to a crankshaft by a multi-speed drive, which could eliminate the need for the recirculation channel.

According to the first embodiment of the invention, the air handling system 80 is provided with a particulate filter 175, which reduces the amount of PM in the exhaust gas that is obtained for recirculation. Preferably the particulate filter is of the regenerative type. A regenerative particulate filter is constructed to collect PM on surfaces of the filter. The collected material is burnt off of the collecting surfaces by passive means such as a catalyst or by active means such as a heater. Oxidation of the collected PM is referred to as “filter regeneration.” Alternatively, a particulate oxidation catalyst (P00) may be used. Because a POC is a passive device, it can present lower flow resistance than a particulate filter; however, a POC is less effective in reducing PM than a particulate filter.

The particulate filter 175 is situated in the EGR channel 131, preferably between the EGR valve 138 and the EGR mixer 163. The EGR filter 175 reduces the amount of PM in the exhaust gas that is obtained for recirculation. Being situated in the EGR channel 131, the EGR filter 175 is located close to the point in the exhaust channel 124 where exhaust gas for recirculation is taken pre-turbine. This ensures that EGR exhaust temperature is high enough to permit passive regeneration of the particulate filter 175 at select engine speeds and loads. Temperatures required for regeneration may be lowered by adding a catalyst wash-coat to the particulate filter 175. The pressure drop introduced by a regenerative particulate filter may be kept low by specifying filtration efficiencies between 50-100% depending on PM tolerance of the supercharger 110 and any coolers in the EGR loop flow path up to the supercharger inlet 151. Both metal foam filters as well as ceramic filters can be used, although the former are preferred because they are more durable in the harsh vibration environment close to the engine.

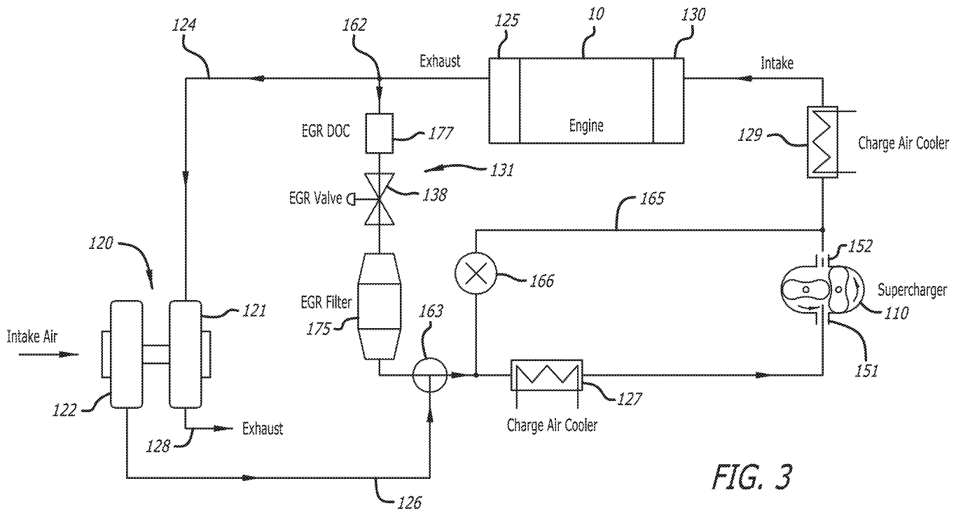

Second Embodiment: FIG. 3 shows the air handling system 80 according to FIG. 2 in greater detail, equipped according to a second embodiment of the invention in which a diesel oxidation catalyst device (DOC) 177 (also called a “catalytic converter”) is placed in the EGR channel 131 to oxidize hydrocarbons, CO, and other materials present in exhaust gas obtained for recirculation. Preferably, the DOC 177 is situated in the EGR channel 131, between the tee coupler 162 and the EGR valve 138. In this instance, recirculated exhaust gas obtained, without separation of PM, by the tee coupling 162 from the exhaust channel 124 flows through the DOC 177 and through the particulate filter 175 thereafter. In this location, the DOC 177 oxidizes hydrocarbons in particular and thus may change the makeup of soot particles by rendering them less ‘sticky’ and therefore less inclined to adhere to and build up on surfaces within the supercharger 110.

Those skilled in the art will realize that the EGR loop configuration shown in FIGS. 2 and 3 may comprise one or more elements in addition to those shown. For example, the EGR channel 131 may also have one or more sensor devices to measure mass flow. Further, the air handling cooling arrangements may include a cooler located in the EGR channel 131. In all cases, a particulate filter, with or without a DOC, according to the invention is positioned upstream of any and all coolers in the charger air channel and/or the EGR channel, as well as the supercharger.

Those skilled in the art will appreciate that the specific embodiments set forth in this specification are merely illustrative and that various modifications are possible and may be made therein without departing from the scope of the invention which is defined by the following claims.

1. An air handling system in an internal combustion engine, comprising:
a source of exhaust gas collected from cylinder exhaust ports of a two-stroke cycle, opposed-piston engine;
a supercharger coupled to an intake manifold of the two-stroke cycle, opposed-piston engine;
an exhaust channel to transport collected exhaust from the exhaust source to a turbine inlet of a turbocharger;
a charge air channel to transport charge air from a compressor outlet of the turbocharger to an inlet of the supercharger;
an exhaust gas recirculation (EGR) channel coupled to transport exhaust gas from the exhaust channel to the charge air channel; and, a particulate filter in the EGR channel.

2. The air handling system of claim 1 her including a diesel oxidation catalyst device in the EGR channel.

3. The air handling system of claim 1, further including a catalytic converter in the EGR channel.

4. The air handling system of claim 1, in which the particulate filter comprises a regenerative particulate filter.

5. The air handling system of claim 4, further including a diesel oxida on c alyst device in the EGR channel.

6. The air handling system of claim 4, further including a catalytic converter in the EGR channel.

7. An air handling system in an internal combustion engine, comprising:
a source of exhaust gas collected from cylinder exhaust ports of a two-stroke cycle, opposed-piston engine;
a supercharger coupled to an intake manifold of the two-stroke cycle, opposed-piston engine;
an exhaust channel to transport collected exhaust from the exhaust source to a turbine inlet of a turbocharger;
a charge air channel to transport charge air from a compressor outlet of the turbocharger to an inlet of the supercharger;
an exhaust gas recirculation (EGR) channel coupled to transport exhaust gas from the exhaust channel to the charge air channel; and, the combination of a regenerative particulate filter and a diesel oxidation catalyst;
in which the diesel oxidation catalyst device is situated upstream of the regenerative particulate filter in the EGR channel.

8. An air handling system with high pressure exhaust gas recirculation (EGR) in an internal combustion engine, comprising:
a source of exhaust gas collected from exhaust ports of a two-stroke cycle, opposed-piston engine;
a supercharger coupled to an intake manifold of the two-stroke cycle, opposed-piston engine;
an exhaust channel to transport collected exhaust from the exhaust source to a turbine inlet of a turbocharger;
a charge air channel to transport charge air from a compressor outlet of the turbocharger to an inlet of the supercharger;
an EGR channel coupled to transport exhaust gas from the exhaust channel to the charge air channel; and,
means for eliminating particulate matter from exhaust gas in the EGR channel by oxidation.

9. An air handling system according to claim 8, wherein the means for eliminating particulate matter comprise a regenerative particulate filter in the EGR channel.

10. An air handling system according to claim 8, wherein the means for eliminating particulate matter comprise a particulate filter in series with a diesel oxidation catalyst device in the EGR channel.

11. An air handling system according to claim 8, wherein the means for eliminating particulate matter comprise a regenerative particulate filter in series with a catalytic converter in the EGR channel.

12. A system in an internal combustion engine, comprising:
a source of exhaust gas collected from cylinder exhaust ports of a two-stroke cycle, opposed-piston engine;
a supercharger coupled to an intake manifold of the two-stroke cycle, opposed-piston engine;
an exhaust channel to transport collected exhaust from the exhaust source;
a charge air channel to transport charge air to an inlet of the supercharger;
an EGR channel coupled to transport exhaust gas from the exhaust channel to the charge air channel; and,
a particulate filter in the EGR channel.

13. The system of claim 12, further including a diesel oxidation catalyst device in the EGR channel.

14. The system of claim 12, further including a catalytic converter in the EGR channel.

15. The system of claim 12, in which the particulate filter comprises a regenerative particulate filter.

16. The system of claim 15, further including a diesel oxidation catalyst device in the EGR channel.

17. The system of claim 15, further including a catalytic converter in the EGR channel.

18. An air handling system with high pressure exhaust gas recirculation (EGR) in an internal combustion engine, comprising:
a source of exhaust gas collected from exhaust ports of a two-stroke cycle, opposed-piston engine;
a supercharger coupled to an intake manifold of the two-stroke cycle, opposed-piston engine:
an exhaust channel to transport collected exhaust;
a charge air channel to transport charge air to an inlet of the supercharger;
an EGR channel coupled to transport exhaust gas from the exhaust channel to the charge air channel; and,
means for eliminating particulate matter from exhaust gas in the EGR channel by oxidation.

19. An air handling system according to claim 18, wherein the means for eliminating particulate matter comprise a regenerative particulate filter in the EGR channel.

20. An air handling system according to claim 18, wherein the means for eliminating particulate matter comprise a particulate filter in series with a diesel oxidation catalyst device in the EGR channel.

21. An air handling system according to claim 18, wherein the means for eliminating particulate matter comprise a regenerative particulate filter in series with a catalytic converter in the EGR channel.
